(19) United States
(12) Patent Application Publication
(10) Pub. No.: US 2004/0193429 A1
(43) Pub. Date: Sep. 30, 2004

(54) MUSIC FILE GENERATING APPARATUS, MUSIC FILE GENERATING METHOD, AND RECORDED MEDIUM

(75) Inventor: Hirohito Kimoto, Tokyo (JP)

Correspondence Address: CONNOLLY BOVE LODGE & HUTZ LLP, SUITE 800, 1990 M STREET NW, WASHINGTON, DC, 20036-3425, US

(73) Assignee: SUNS-K CO., LTD., Tokyo (JP)

(21) Appl. No.: 10/708,579

(22) Filed: Mar. 12, 2004

(30) Foreign Application Priority Data
Mar. 24, 2003 (JP) 2003-081401

(51) Int. Cl. G10L 11/00

(52) U.S. Cl. 704/278

(57) ABSTRACT

A singing voice extraction section 2 that extracts human singing voices from the digital sound generator data 11 and obtains the signing voice data 12 in the ADPCM format, the BGM generating section 13 that generates the BGM data 13 in the MIDI format, the MIDI adjustment section 4 that generates simulated singing voice data in the MIDI format based on the extracted signing voices and adds such data to the BGM data 13, and the file generating section 5 that processes the singing voice data 12 and the BGM and simulated singing voice data 14 into a single music file 15 are established. Bandwidth limiting is significantly executed for the singing voice portion. Through generating the BGM portion in the MIDI format, the entire amount of data is decreased, and the singing voice portion that has been deteriorated in quality due to the performance of bandwidth limiting is supplemented by MIDI data. Due to this, the quality of the reproduced singing voices can be also maintained beyond a predominating level.

### BACKGROUND OF THE INVENTION

1. Field of the Invention

The present invention relates to a music file generating apparatus, music file generating method, and recorded medium that has a specific data structure. In particular, it relates to the method for generating a music file that is composed of human singing voices and BGM (Back Ground Music), and the data structure of such music file.

2. Description of the Related Art

Recently, the cellular phone has spread explosively and has become a ubiquitous form of equipment. A characteristic of the ringtones of the initial type of cellular phones was only to repeat quite simple patternized sounds. However, later on, based on market needs pursuing more unique sounds, so-called melody signaling an incoming call (hereinafter referred to as the “ringtone-melody”) emerged. These make ringtones using melodies issued using MIDI (Music Instrument Digital Interface) data.

Additionally, cellular phones incorporating a PCM sound generator emerged several years ago. Currently, the so-called voice signaling an incoming call (hereinafter referred to as the “ringtone-voice”) have been realized. This makes ringtone of the voices of the artists, etc. using the PCM sound source. Such ringtone melodies and ringtone voices can be used by downloading desired examples from Internet sites. Users can turn their cellular phones into phones reflecting “their own tastes” by downloading the contents they prefer to the cellular phones.

In recent years, due to the advancement of cellular phone equipment, so-called music signaling an incoming call (hereinafter referred to as the “ringtone-music”) has been newly provided that uses music files that have been recorded on CDs (compact disk), etc. as cellular phone ringtones (involving not simply melody sounds or human voices, but music file ringtones integrating the human voices with BGM). This type of ringtone-music system extracts a part of the data from a CD sound source, compresses such data in the format of MP3 files (MPEG1 Audio Layer-3), etc. and uses such data as contents for distribution.

However, the conventional ringtone-music system simply extracts a part of the data of the CD sound source, and such data constitutes contents for distribution. Thus, the data amount of ringtone-music system contents is much larger than that constituting a conventional ringtone melodies (MIDI data) or ringtone voices (PCM data). In order to download and use such contents, a large cellular phone memory capacity is required.

So as to reproduce ringtone-music to the extent that such ringtone-music can be recognized as at least a music, it is necessary to extract data from the CD sound source corresponding to an amount equal thereto. Thus, even when the extracted data is compressed in the MP3 format, the small memory capacity of existing cellular phone equipment does not appropriately respond to such situation.

Additionally, existing cellular phone equipment has a reproduction function for only the MIDI sound source or the PCM sound source. However, no reproduction function for the MP3 format is installed.

As described above, the conventional ringtone-music system involves a remarkably large memory capacity and a new model with an MP3 format decoder, and it has not been possible to use the services unless cellular phone equipment constitutes these functions. One of the reasons why ringtone melodies and ringtone voices experienced a large boom is that the reproduction functions of MIDI sound source and PCM sound source that are possessed by cellular phone equipment in a standard manner can be used as they are. Therefore, it is also desired for ringtone-music services to be used even with existing models of cellular phone equipment.

### SUMMARY OF THE INVENTION

The present invention has been made in light of such actual conditions. The purpose of the present invention is to allow the use of music composed of singing voices and BGM as ringtones, even for current cellular phones without large memory capacities or MP3 decoders, etc.

A music file generating apparatus of the present invention comprises a singing voice extraction means that extracts singing voices from digital voice data in which the singing voices and voices other than such singing voices are mixed, and obtains the singing voice data in the PCM format; a MIDI generating means that generates the BGM data in the MIDI format, generates the simulated singing voice data in the MIDI format corresponding to the singing voices extracted by the singing voice extraction means, adds the simulated singing voice data to the BGM data, and adjusts the MIDI data; and a file generating means that processes the singing voice data in the PCM format generated by the singing voice extraction means and the BGM and simulated singing voice data in the MIDI format generated by the MIDI generating means as a single music file. The voices other than the singing voices are BGM or noises.

In another aspect of the present invention, the singing voice extraction means performs a procedure of bandwidth limiting of the digital voice data composed of a mixture of the singing voices and the voices other than singing voices up to a predominated frequency band corresponding to the singing voices.

In another aspect of the present invention, the music file generated by the file generating means is structured to include MIDI reproduction control information so as to reproduce BGM and simulated singing voice data in the MIDI format generated by said MIDI generating means and PCM reproduction control information so as to synthesize the singing voice data in the PCM format generated by the singing voice extraction means for the simulated singing voice data and to reproduce such singing voice data.

Also, a music file generating method of the present invention comprises a first step that extracts the singing voices from the digital voice data composed of a mixture of the singing voices and voices other than such singing voices, and obtains the singing voice data in the PCM format; a second step that generates BGM data in the MIDI format; a third step that generates simulated singing voice data in the MIDI format corresponding to the singing voices extracted in the first step, adds the simulated singing voice data to the BGM data generated in the second step, and adjusts the MIDI data; and a fourth step that processes the singing voice data in the PCM format generated in the first step and the BGM and simulated singing voice data in the MIDI format adjusted in the third step into a single music file.

In another aspect of the present invention, in the first step, a procedure of bandwidth limiting of the digital voice data composed of a mixture of the singing voices and voices other than the singing voices up to a predominated frequency band corresponding to the singing voices is performed.

In another aspect of the present invention, in the fourth step, a procedure of adjustment is performed to synthesize the reproduction timing of the singing voice data in the PCM format generated in the second step, and the BGM and simulated singing voice data in the MIDI format generated in the third step.

In another aspect of the present invention, the music file generated in the fourth step is structured to include the MIDI reproduction control information so as to reproduce the BGM and simulated singing voice data in the MIDI format generated in the third step, and the PCM reproduction control information so as to synthesize the singing voice data in the PCM format generated in the second step for the simulated singing voice data and to reproduce such singing voice data.

Additionally, a recorded medium readable by computer comprises PCM data composed of singing voices in the PCM format; and MIDI data where simulated singing voice data in the MIDI format that is generated corresponding to the singing voices of the PCM data is added to BGM data in the MIDI format. And a music file with a data structure where the PCM data and the MIDI data are integrated into a single file is recorded.

In another aspect of the present invention, the music file includes the MIDI reproduction control information so as to reproduce the MIDI data, and the PCM reproduction control information so as to synthesize the PCM data to the MIDI data and to reproduce such PCM data.

As explained above, according to the present invention, the data amount of the music file can be reduced to an extent that such amount falls within the limit scope of the file capacity relating to ringtones of current cellular phone models. And the quality of reproduced voices can be also maintained beyond the predominating level. Due to this, even current cellular phone models without large memory capacities or MP decoders, etc. can use the services of ringtone-music.

### BRIEF DESCRIPTION OF THE DRAWINGS

FIG. 1 is a diagram showing an example of the structure of the music file generating system of the embodiment.

FIG. 2 is a conceptual diagram showing the data structure of a music file of the embodiment.

FIG. 3 is a flowchart showing the procedures of the music file generating method of the embodiment.

FIG. 4 is a diagram showing an example of the structure of music distribution system of the embodiment.

FIG. 5 is a flowchart showing operations regarding music distribution and customer registration in the music distri-bution server of the embodiment.

### DETAILED DESCRIPTION OF THE PREFERRED EMBODIMENTS

Hereinafter, one embodiment of the present invention will be described based upon the drawings.

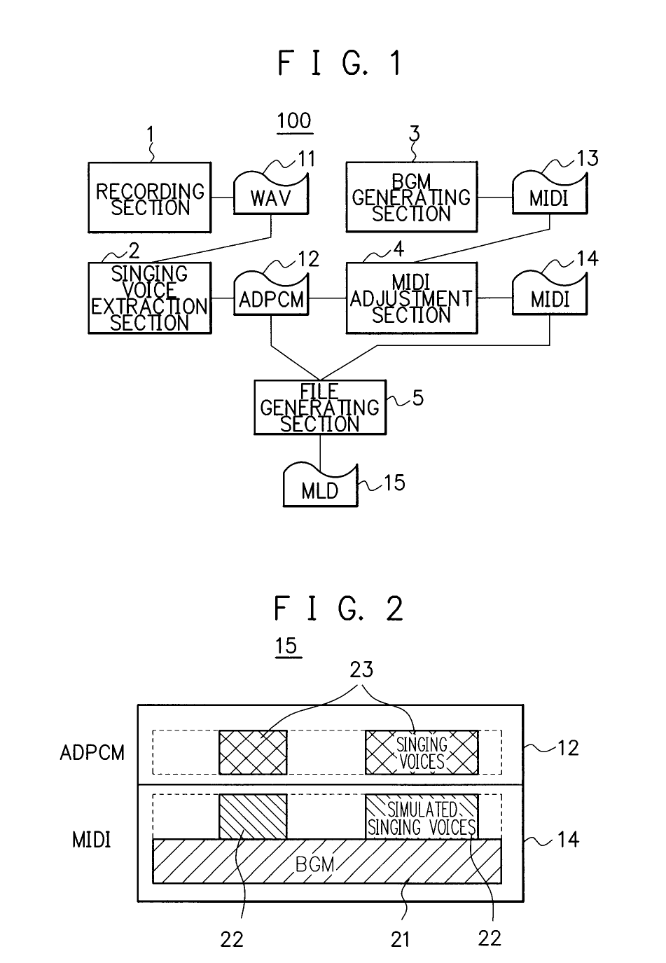

FIG. 1 is a diagram showing an example of the structure of the music file generating system of the embodiment.

As shown in FIG. 1, the music file generating system 100 of the embodiment is composed of the recoding section 1, the singing voice extraction section 2, the BGM generating section 3, the MIDI adjustment section 4, and the file gen-erating section 5.

The recoding section 1 records digital sound source data such as that from a CD (Compact Disc) or DVD (Digital Versatile Disk) into the hard disk of a computer in WAV format. For instance, a commercial CD is set in a CD drive of a personal computer (hereinafter referred to as the “PC”), and the digital sound generator data 11 in the WAV format can be obtained by recording the CD onto the hard disk build into the PC.

Additionally, the WAV format is an audio file format standardized by Windows (registered trademark), and is also known as the WAVE format. This is regulated as a format to save a file so as to record a digital audio signal. An optional compression method can be used. In the default mode, responses are made by a compression method such as the PCM (non-compression) format or ADPCM (Adaptive Differential Pulse Code Modulation) format.

The singing voice extraction section 2 extracts several desired measures (for example, the head portion or sabi portion (the most heard and most popular part of a song) of a music file) from the digital sound source data 11 in the WAV format in which the human singing voices and BGM are mixed. And by subsequently eliminating the BGM, human singing voices alone are extracted. At this time, in accordance with the reproduction format implemented in the cellular phone, the digital sound source data 11 in the WAV format is converted into the singing voice data 12 in the ADPCM format.

Specifically, using the example of a CD, bandwidth limiting is executed up to a predominated frequency band (4 KHz or 8 KHz) corresponding to human singing voices for the digital sound source data 11, regarding which sampling is executed by 44.1 KHz. That it to say, sampling of the digital sound source data 11 is executed for certain successive intervals equivalent to 4 KHz or 8 KHz. The PCM format is applied to the simple sampling. However, using of the fact that sounds are further consecutively changed, the difference between the immediately preceding sampling data is recorded so as to decrease the data amount. This is the ADPCM format.

The BGM generating section 3 generates the BGM data 13 in the MIDI format. Here, for example, a PC is equipped with a MIDI sound source, and BGM is created by DTM (Desk Top Music) using the application program known as sequence software, which is installed in such PC. The BGM data 13 generated here is the BGM equivalent to the portion eliminated in the singing voice extraction section 2. In addition, DTM is one example of a MIDI data generating method, and the present invention is not limited to such generating method.

When the singing voice data 12 extracted at the singing voice extraction section 2 and the BGM data 13 generated at the BGM generating section 3 are combined, a music file of the same origin as a digital sound source, such as a CD, can be made. The singing voice data 12 is generated by bandwidth limiting of the original digital sound source data 11 to a great extent, and the data amount is significantly decreased. Additionally, the BGM data 13 is based on the MIDI format. Thus, the data amount is small originally. Therefore, compared with data that is simply extracted from a part of the CD sound source and is compressed in the MP3 format, the data amount is extremely small.

However, deterioration has occurred to the singing voice data 12 extracted at the singing voice extraction section 2, and even if such data is reproduced as is, such data can be hardly recognized as representing a human voice. When the sampling frequency is greater, the deterioration is suppressed. However, the data amount of the singing voice data 12 becomes larger. Therefore, the embodiment adopts a method to boost the human singing voices by MIDI data, to avoid enlargement of the data amount of the singing voice data 12, and to maintain the quality of the outputted singing voices above a certain level. In order to achieve such method, the MIDI adjustment section 4 is adopted.

In the MIDI adjustment section 4, along with the pitch, tempo, tone, and volume of the singing voices extracted at the singing voice extraction section 2, simulated singing voice data in the MIDI format where such singing voice is simulated is generated. Such simulated singing voice data is added to the BGM data, and the MIDI data is adjusted. Such adjustment of the MIDI data is also executed by DTM, for example.

Even when such generated simulated singing voice data is reproduced, such data does not sound like a human singing voice. However, when such data is reproduced simultaneously with the singing voice data 12 extracted at the singing voice extraction section 2, the deteriorated portion of the singing voice data 12 in the ADPCM format is supplemented clearly by the simulated singing voice data in the MIDI format, and can have as good a sound quality as a human singing voice.

The file generating section 5 executes a procedure to process the singing data 12 in the ADPCM format, which has been generated at the singing voice extraction section 2, and the BGM and simulated singing voice data 14 in the MIDI format, which has been adjusted at the MIDI adjustment section 4, into a single music file 15. The music file 15 generated here is written according to the formats of the cellular phone carriers themselves. In the example of NTT DoCoMo, Inc., the music file 15 in the MLD format is generated in accordance with MFi (Melody Format for i-mode; i-mode is a registered trademark).

As mentioned above, it is important to simultaneously reproduce the singing voice data 12 in the ADPCM format and the simulated singing voice data 14 in the MIDI format without a gap. Thus, when the music file 15 in the MLD format is generated, the adjustment that synchronizes the reproducing timing of the singing voice data 12 and BGM and simulated singing voice data 14 is made.

Specifically, the performance position information of binary that is defined in the MLD format (such as the positions of start and end, and time of sound production regarding performance) is appropriately set for both of the singing voice data 12, and BGM and simulated singing voice data 14.

Each functional block 1 to 5 of the music file generating system 100 structured as above is structured to include a CPU or MPU, RAM, and ROM of a computer in actuality, and can be realized through the operations of programs stored in the RAM or the ROM.

FIG. 2 is a conceptual diagram showing an imaginary data structure of the music file 15. Generally, an MLD file has the following 3 sections: a file header section including the identifier of the file itself, a data information section including the file data, and a track section including the actual music data. FIG. 2 shows a simulated structure of the track section.

As shown in FIG. 2, the music file 15 includes singing voice data 12 in the ADPCM format, and BGM and simulated singing voice data 14 in the MIDI format. In FIG. 2, a horizontal axis indicates the time direction, and the hatching portion indicates the reproduction timing of the BGM 21, the simulated singing voices 22, and the singing voices 23. In the example of FIG. 2, the BGM 21 of the MIDI consistently flows from the beginning to the end, and the simulated singing voices 22 of the MIDI is played at two places in the process thereof. This shows that simultaneously with playing of such simulated singing voices 22, the singing voices 23 of the ADPCM is also played.

Regarding the BGM and simulated singing voice data 14 in the MIDI format, the BGM 21 portion and the simulated singing voices 22 portion may be generated as separate MIDI data, or may be generated as a single piece of MIDI data. In the former case, the performance position information regarding the BGM 21 and the performance position information regarding the simulated singing voices 22 are separately established. In the latter case, the BGM 21 and the simulated singing voices 22 are defined as chord data. That it to say, regarding the timing when the simulated singing voices 22 are not played, a single piece of MIDI data is defined as only the chords of BGM 21. Regarding the timing when the simulated singing voices 22 are played, a single piece of MIDI data is defined as the chords that combine the BGM 21 with the simulated singing voices 22. In such case, the performance position information is defined for such single piece of MIDI data.

Meanwhile, concerning the singing voices 12 in the AD-PCM format, the performance position information regarding the singing voices 23 is established so that the singing voices 23 is played simultaneously with the simulated singing voices 22.

As such, the music file 15 of the embodiment is structured to include the necessary MIDI reproduction control information so as to reproduce the BGM and simulated singing voice data 14 in the MIDI format with appropriate timing, and the necessary PCM reproduction control information so as to synchronize the singing voice data 12 in the ADPCM format with the BGM and simulated singing voice data 14 and to reproduce such data with appropriate timing.

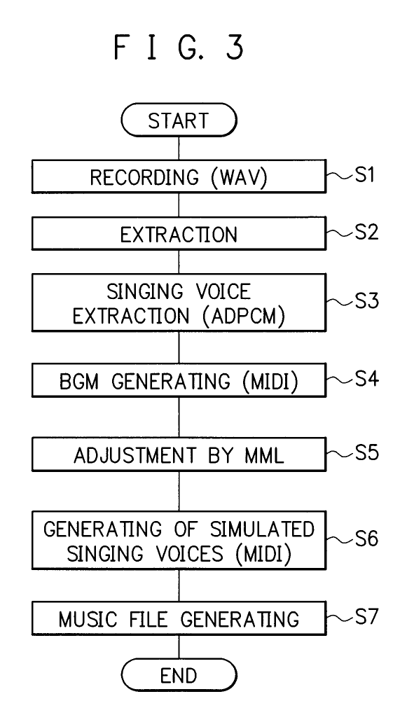

FIG. 3 is a flowchart showing the procedures of the music file generating method of the embodiment. In FIG. 3, the recording section 1 records digital sound source data 11 such as that from a CD or DVD onto the hard disk of the computer in the WAV format (Step S1). Next, the singing voice extraction section 2 extracts a desired portion (for example, the head portion or sabi portion of the music file) of the recorded digital sound source data 11 in the WAV format (Step S2). The extracted portion is not limited to only a single portion, and may be a plurality portions. Also, the extracted plurality of portions may be consolidated and assembled as one.

Such extraction procedure may be executed in accordance with instructions given by the users, using a keyboard or mouse, etc., or may be automatically performed by the computer. When the computer automatically performs such procedure, upon extracting the head portion of the music, it is possible to give instructions regarding the number of measures to be extracted, and to automatically extract the corresponding portions. Also, when the sabi portion is extracted, it is possible to predict the sabi portion through detecting the beginning of a background chorus, a change of the volume, or change of melody, etc., and to automatically extract such sabi portion.

Furthermore, the singing extraction section 2 executes the procedure of bandwidth limiting up to the predominated frequency band (4 KHz or 8 KHz) corresponding to a human singing voice, for the extracted digital sound source data 11 so as to eliminate the BGM and to extract only the human singing voice (Step S3). This can generate the singing voice data 12 in the ADPCM format. In addition, when the extraction procedure is performed based on the instructions of the users, the order regarding the procedures of Step S2 and Step S3 may be reversed.

Additionally, the BGM generating section 3 generates BGM data 13 equivalent to the eliminated portion at the singing voice extraction section 2 in the MIDI format by DTM, etc. (Step S4). The BGM data 13 in the MIDI format greatly depends on the model of the cellular phone built-in sound source. Thus, the expression method is adjusted to each model by MML (Music Markup Language) (Step S5). Next, the MIDI adjustment section 4 generates simulated singing voice data in the MIDI format that simulates the extracted signing voices at the singing voice extraction section 2, adds such data to the BGM data, and makes an adjustment of the MIDI data (Step S6). In addition, the order of the procedures of Step S1 to S3 and the procedures of Step S4 to S6 may be reversed.

Finally, the file generating section 5 processes the singing voice data 12 in the ADPCM format, which has been generated in Step S1 to S3, and the BGM and simulated singing voice data 14 in the MIDI format, which have been generated in Step S4 to S6, into a single music file 15 (Step S7). Here, the binary data is written according to the formats of cellular phone carriers themselves. In the aforementioned example, the MLD format of DoCoMo Inc. is explained. Music file 15 is generated in accordance with the PMD format regarding au by KDDI, and in accordance with the SMD format regarding J-phone by Vodafone K.K. Music files 15 corresponding to a plurality of carriers for a single piece of music may be generated.

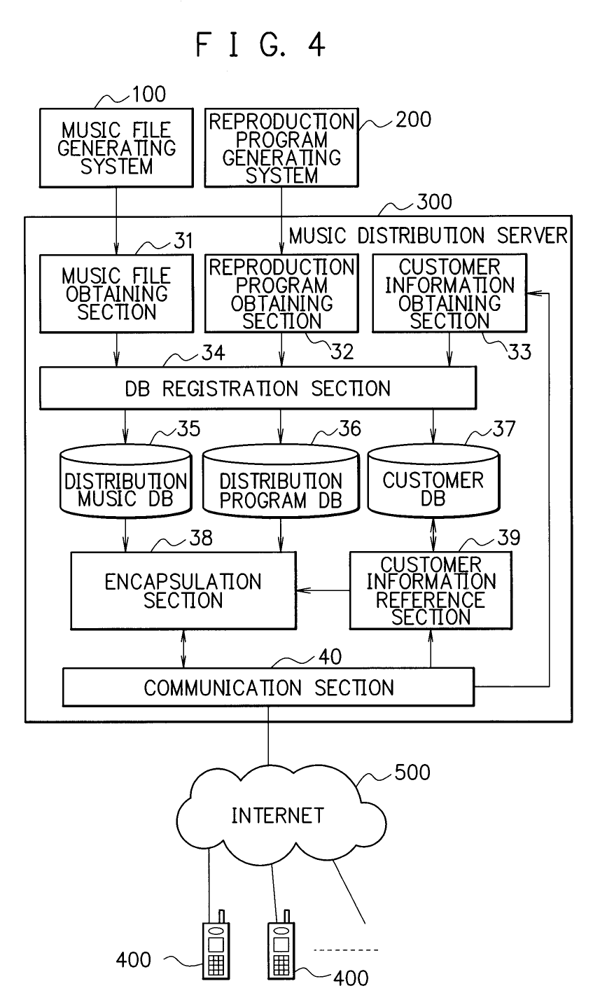

FIG. 4 is a diagram showing an example of the structure of music distribution system of the embodiment using the music file 15, which is generated as above. In FIG. 4, 300 denotes a music distribution server to distribute the music file 15, and 400 denotes a cellular phone to receive the distributed music file 15. These can be accessible by the Internet 500.

As shown in FIG. 4, the music distribution server 300 is composed of the music file obtaining section 31, the reproduction program obtaining section 32, the customer information obtaining section 33, the data base (DB) registration section 34, the distribution music DB 35, the distribution program DB 36, the customer DB 37, the encapsulation section 38, the customer information reference section 39, and the communication section 40.

The music file obtaining section 31 obtains the music file 15 generated by the music file generating system 100 within the music distribution server 300. The reproduction program obtaining section 32 obtains the music reproduction program (music reproduction player) generated by the reproduction program generating system 200 within the music distribution server 300.

Such music file obtaining section 31 and reproduction program obtaining section 32 specifically adopt the music file 15 or a music reproduction program via a recorded medium, such as a CD, a flexible disk, within the music distribution server 300. And such sections 31 and 32 adopt the music file 15 or the music reproduction program, via the Internet 500 or another network (not illustrated) within the music distribution server 300.

The music reproduction program gives instructions of the performance regarding the BGM 21, the simulated singing voices 22, and the singing voices 23 in accordance with the performance position information, which is recorded in the music file 15. This includes the PCM reproduction control program, which provides instruction regarding the performance of the singing voice data 12 in the ADPCM format to the synthesizer built into the cellular phone equipment, and the MIDI reproduction control program, which provides instruction regarding the performance of the BGM and simulated singing voice data 14 in the MIDI format to the synthesizer. Such music reproduction program is also elaborated in accordance with differences of the specifications of each cellular phone carrier.

The customer information obtaining section 33 obtains some information relating to customers (for example, name, user ID, password, carrier or model of cellular phone 400 used by customers). Specifically, when users initially access the music distribution server 300 via the Internet 500 from the cellular phone 400, a request regarding inputting of information is made to the users (for example, the information input screen is presented). Necessary customer information is obtained by this.

The DB registration section 34 registers the music file 15 responding to various specifications obtained by the music file obtaining section 31 at the distribution music DB 35, as the music data file for ringtone-music. Also, the music reproduction program responding to various specifications obtained by the reproduction program obtaining section 32 is registered at the distribution program DB 36. The customer information obtained by the customer information obtaining section 33 is registered at the customer DB 37. The distribution music DB 35 comprises the recorded medium of the present invention.

According to distribution requests from users, the encapsulation section 38 reads the music file 15 corresponding to the carrier and model of the cellular phone 400 used by the users, from the distribution music DB 35. Also, the encapsulation section 38 reads the music reproduction program corresponding to such carrier and model of the cellular phone 400 from the distribution program DB 36, encapsulates such music file 15 and music reproduction program, and issues a concatenated file. When the distribution requests are made by users, the customer information reference section 39 performs a procedure to identify the carrier and model of the cellular phone 400 used by the users who have made a request by referring to the customer DB 37, and to deliver such information to the encapsulation section 38.

Encapsulation means a procedure whereby the binary data of the music file 15 and the binary data of the music reproduction program are combined together as a single file. Encapsulation is implemented as a system that uses the delivery procedure of the class of Java (registered trademark) where the generated objects are consolidated by self-contained type, and starts up the program at the time of an incoming phone call. In addition, the method to encapsulate the music reproduction program into the music file 15 involves a method to perform a dynamic combination at the time of request for music distribution, and a method to prepare a static combination by prior batch processing in advance. The embodiment is available for any such methods.

Also, the distribution file can adopt any of method to comply with the Java file, or method to establish an optional file format and comply with the protocol of file self-reproduction. Regarding the distribution file, the physical partitioning structure is not a problem. It is required to have a logically single file structure. Regarding logical unity, it may be sufficient for the process that structures the implementation environment to meet the conditions of conclusion upon operationality when users download music.

The communication section 40 performs procedures relating to communication with the cellular phone 400 via the Internet 500. For example, such section 40 performs procedures to convey a customer information which is transmitted from the cellular phone 400 to the customer information obtaining section 33. Also, such section 40 performs procedures to receive a request for desired music distribution, which is transmitted from the cellular phone 400, and to convey such request to the encapsulation section 38 and the customer information reference section 39. Also, such section 40 performs a procedure to distribute the concatenated file generated by the encapsulation section 38 to the cellular phone 400 of the requesting party. The memories (not illustrated) within the cellular phone 400 which stores the music file 15 included in the concatenated file also consist the recorded medium of the present invention.

The operations of all functional blocks 31 to 34 and 38 to 40 within the music distribution server 300 explained above are controlled by the control section (not illustrated), which is composed of a CPU or MPU, ROM, and RAM, etc. Also, all DBs 35 to 37 are composed of a recorded medium, such as a hard disk.

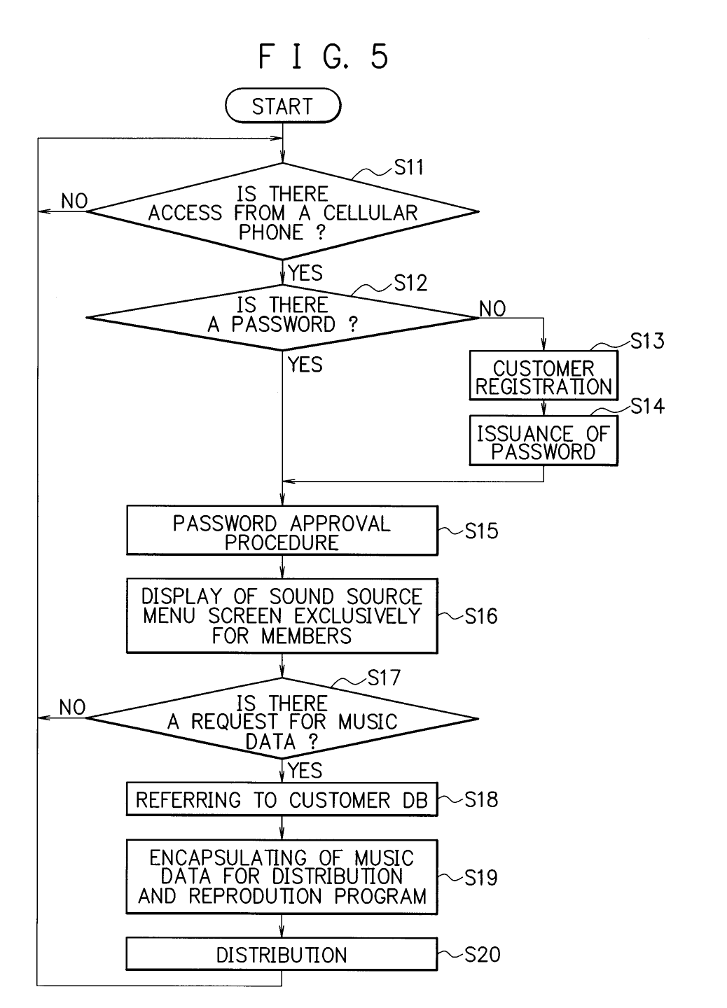

Next, the operations of the music distribution system of the embodiment structured above are explained with reference to the flowchart in FIG. 5. FIG. 5 is a flowchart showing the operations of music distribution and customer registration in music distribution server 300 of the embodiment.

As shown in FIG. 5, the control section not illustrated in the music distribution server 300 judges whether access from the cellular phone 400 to the communication section 40 has been made or not (Step Sll). When access has been made from the cellular phone 400, the control section further judges whether a password has been already established for the user of the cellular phone 400 or not (Step S12). Here, whether access with inputting of password has been made or not is judged.

When no password has been established for such user, the control section presents the predominated information input screen to the cellular phone 400 by using the communication section 40, and urges the users to input customer information. The customer information that is inputted thereby in response is obtained by the customer information obtaining section 33, and the DB registration section 34 registers such information at the customer DB 37 (Step S13). After this, the control section issues a password unique to the user (Step S14).

When it is judged that a password has been already issued to the user in the aforementioned Step S12 (when access involving the inputting of a password has been made), and when a password is newly issued in the aforementioned Step S14, the control section performs an approval procedure relating to such password (Step S15). When a password is incorrect, a warning message to this effect is outputted, and the procedure is suspended.

Meanwhile, when the approval of the password is completed, the control section presents the sound source menu screen exclusively for the members to the cellular phone 400 by using the communication section 40 (Step S16). Through this sound source menu screen, the users can request downloading of the desired music to the music distribution server 300. The control section judges whether the cellular phone 400 has made a request for distribution of the desired music or not (Step S17). If not, the procedure returns to Step S11.

When a request for distribution of the desired music has been made, the customer information reference section 39 identifies the carrier and model of the cellular phone 400 of the requesting party by referring to the customer DB 37, and conveys such information to the encapsulation section 38 (Step S18). The encapsulation section 38 reads the music reproduction program corresponding to the carrier and model conveyed by the customer information reference section 39 from the distribution program DB 36, reads the music file 15, which the user has made a request of distribution, corresponding to the carrier and model conveyed by the customer information reference section 39 from the distribution music DB 35 encapsulates such music reproduction program and music filel5, and issues the concatenated file (Step S19).

Finally, the concatenated file generated by the encapsulation section 38 is distributed to the cellular phone 400 by the communication section 40 (Step S20). The cellular phone 400, which has received such concatenated file, executes the reproduction of the music file 15 by the music reproduction program included therein.

As explained in detail as above, according to the embodiment, the digital sound source, such as a CD, is divided into a singing voice portion and a BGM portion. Regarding the singing voice portion, bandwidth limiting is greatly executed thereto, and the data amount is decreased due to the use of the ADPCM format. Regarding the BGM portion, data is generated in the MIDI format, and the data amount is decreased. Due to this, the data amount can be dramatically reduced, compared with the conventional method, which simply extracts data from the CD sound source, etc., and compresses it into an MP3 format. Also, since the deteriorated singing voice portion through performance of bandwidth limiting is supplemented by the MIDI data, the quality of reproduced singing voices can be maintained beyond the predominating level.

Therefore, while the limitation of file capability, which provides restrictions relating to the ringtones of current models of cellular phone equipment (10 Kbyte for NTT DoCoMo, Inc., for example) is maintained, it is possible to distribute and reproduce a ringtone-music sound with quality beyond a certain level that can be guaranteed. That is to say, according to the embodiment, even current models of cellular phone equipment that are not equipped with large memory capacities or MP3 decoders, etc. can use the ringtone-music services.

Note that, regarding the embodiment mentioned above, an example of generating the music file 15 for the ringtones of the cellular phone is explained. However, this is not limited to the purpose of ringtones. It is possible to apply the music file 15 of the embodiment to a system that requires reproduction of music composed of singing voices and BGM with a small memory capacity. In such case, as the recorded medium that stores the music file 15, a CD-ROM, flexible disk, hard disk, magnetic tape, optical disk, magnetic optical disk, DVD, or nonvolatile memory, etc. can be used, and these items comprise the recorded medium of the present invention.

Additionally, in the aforementioned embodiment, an example where the recording section 1 records digital sound source data such as that of a CD or DVD to the hard disk of the computer, etc. in the WAV format, is explained. However, the embodiment is not limited thereto. For instance, it may be suitable that the singing voices of a user overlaying the BGM of karaoke at amusement facilities, such as karaoke boxes or game centers, are inputted from a microphone and recorded in the WAV format. In such cases, surrounding noises as well as the singing voices are simultaneously recorded. However, through performing the same procedures as those of the aforementioned embodiment by the singing voice extraction section 2, BGM generating section 3, MIDI adjustment section 4, and file generating section 5, a high-quality ringtone-music file that can be made by the user's singing voices without any noises can be generated.

In such example, it is possible that the recording apparatus with the functions of the recording section 1 can be established independently at amusement facilities, such as karaoke boxes or game centers, and a computer for editing separately from such recording apparatus can be equipped with the functions of the singing voice extraction section 2, BGM generating section 3, MIDI adjustment section 4, and file generating section 5. In such cases, the data recorded at the recording section 1 may be inputted into the computer for editing via the recoded medium such as a CD, flexible disk, hard disk, magnetic tape, optical disk, magnetic optical disk, DVD, or nonvolatile memory card, etc. Or, such data may be transmitted to the computer for editing from the recording apparatus via a communication network, such as the Internet. The generated ringtone-music file may be also transmitted to the cellular phone of the users from the computer for editing via the commutation network.

Also, an apparatus with all functions of the recording section 1, singing voice extraction section 2, BGM generating section 3, MIDI adjustment section 4, and file generating section 5 may be established at amusement facilities such as karaoke boxes or game centers. In such cases, the BGM generating section 3 can replace the function to keep the BGM data in the MIDI format, which is reproduced in karaoke when singing voices are recorded, in advance. That is to say, BGM data in the MIDI format that has been stored in advance is reproduced when the singing voices are recorded. And, a ringtone-music file is generated using the same BGM data and the singing voice data extracted from the recorded voices. At this time, the MIDI adjustment section 4 analyzes the pitch, tempo, tone, and volume of the singing voices recorded along with karaoke and generates the simulated singing voice data in the MIDI format based on such results, and such data is added to the BGM data.

In addition, the embodiments explained above have shown only one example of the possible incarnations upon implementing the present invention. This should not cause the technical scope of the present invention to be restrictively interpreted. That is to say, the present invention can be implemented in various forms, without deviating from the spirit or the main characteristics thereof.

Furthermore, other embodiments of the present invention are collectively described hereinafter.

1. A data distribution system that distributes a music file from the data distribution sever to the requesting terminals, comprising:

a data storage means that beforehand stores the music file generated by the music file generating apparatus according to claim 1;

a reproduction program storage means that beforehand stores the reproduction program corresponding to each specification of the terminals; and

a transmission means that reads the corresponding music file from the data storage means, reads the reproduction program corresponding to the specifications of the requesting terminals from the reproduction program storage means, based on a request for the desired data distribution from the requesting terminals, and transmits the music file and the reproduction program to the requesting terminals.

2. The data distribution system according to paragraph 1 above, wherein the transmission means includes an encapsulation means to logically encapsulate the music file and the reproduction program into a single file.

3. A data distribution sever that distributes a music file to the requesting terminals, comprising:

a data storage means that stores the music file generated by the music file generating apparatus according to claim 1;

a reproduction program storage means that stores the reproduction program corresponding to each specification of the terminals;

a transmission means that reads the corresponding music file from the data storage means, reads the reproduction program corresponding to the specifications of the requesting terminals from the reproduction program storage means, based on a request for the desired data distribution from the requesting terminals, and transmits the music file and the reproduction program to the requesting terminals.

4. The data distribution sever according to paragraph 3 above, wherein the transmission means includes an encapsulation means to logically encapsulate the music file and the reproduction program into a single file.

Industrial Applicability

This present invention is useful in that currently available cellular phones without large memory capacities or MP3 decoders, etc. can use music files composed of singing voices and BGM as ringtones.

1. A music file generating apparatus, comprising:
a singing voice extraction means that extracts singing voices from digital voice data in which said singing voices and voices other than such said singing voices are mixed, and obtains the singing voice data in the PCM format;
a MIDI generating means that generates the BGM data in the MIDI format, generates simulated singing voice data in the MIDI format corresponding to the singing voices extracted by said singing voice extraction means, adds said simulated singing voice data to said BGM data, and adjusts the MIDI data; and
a file generating means that processes the singing voice data in the PCM format generated by said singing voice extraction means and the BGM and simulated singing voice data in the MIDI format generated by said MIDI generating means as a single music file.

2. The music file generating apparatus according to claim 1, wherein said voices other than singing voices are BGM.

3. The music file generating apparatus according to claim 1, wherein said voices other than singing voices are noises.

4. The music file generating apparatus according to claim 1, wherein said singing voice extraction means performs a procedure of bandwidth limiting of the digital voice data composed of a mixture of said singing voices and said voices other than singing voices up to a predominated frequency band corresponding to said singing voices.

5. The music file generating apparatus according to claim 1, wherein the music file generated by said file generating means is structured to include the MIDI reproduction control information so as to reproduce said BGM and simulated singing voice data in the MIDI format generated by said MIDI generating means, and the PCM reproduction control information so as to synthesize said singing voice data in the PCM format generated by said singing voice extraction means for said simulated singing voice data and to reproduce such singing voice data.

6. A music file generating method, comprising:
a first step that extracts singing voices from the digital voice data composed of a mixture of said singing voices and voices other than said singing voices, and obtains the singing voice data in the PCM format;
a second step that generates BGM data in the MIDI format;
a third step that generates simulated singing voice data in the MIDI format corresponding to the singing voices extracted in said first step, adds said simulated singing voice data to the BGM data generated in said second step, and adjusts the MIDI data; and
a fourth step that processes the singing voice data in the PCM format generated in said first step and the BGM and simulated singing voice data in the MIDI format adjusted in said third step into a single music file.

7. The music file generating method according to claim 6, wherein said voices other than singing voices are BGM.

8. The music file generating method according to claim 6, wherein said voices other than singing voices are noises.

9. The music file generating method according to claim 6, wherein in said first step, a procedure of bandwidth limiting of the digital voice data composed of a mixture of said singing voices and said voices other than singing voices up to a predominated frequency band corresponding to said singing voices is performed.

10. The music file generating method according to claim 6, wherein in said fourth step, a procedure of adjustment is performed to synthesize the reproduction timing of said singing voice data in the PCM format that has been generated in said second step, and said BGM and simulated singing voice data in the MIDI format generated in said third step.

11. The music file generating method according to claim 6, wherein the music file generated in said fourth step is structured to include the MIDI reproduction control information so as to reproduce said BGM and simulated singing voice data in the MIDI format generated in said third step, and the PCM reproduction control information so as to synthesize said singing voice data in the PCM format generated in said second step for said simulated singing voice data and to reproduce such singing voice data.

12. A recorded medium readable by computer, comprising:
PCM data composed of singing voices in the PCM format; and
MIDI data where simulated singing voice data in the MIDI format that is generated corresponding to the singing voices of said PCM data is added to BGM data in the MIDI format;
wherein a music file with a data structure where said PCM data and said MIDI data are integrated into a single file is recorded.

13. A recorded medium readable by computer according to claim 12, wherein said music file includes the MIDI reproduction control information so as to reproduce said MIDI data, and the PCM reproduction control information so as to synthesize said PCM data to said MIDI data and to reproduce such PCM data.
